(19) United States
(12) Patent Application Publication
(10) Pub. No.: US 2011/0111739 A1
(43) Pub. Date: May 12, 2011

(54) Method for forming the emotional and mental approach of sportsmen.

(76) Inventor: Nikolai Borisovich Borodulin, Saint-Petersburg (RU)

(21) Appl. No.: 13/001,041

(22) PCT Filed: Sep. 16, 2008
(86) PCT No.: PCT/RU08/00598

§ 371 Date: Dec. 22, 2010

(30) Foreign Application Priority Data
Jun. 26, 2008 (RU) 2008129210

(51) Int. Cl. H04M 3/42

(52) U.S. Cl. 455/414.1

(57) ABSTRACT

The invention relates to methods for influencing the emotional and mental approach of a sportsman, in particular a football player. The inventive method for forming the emotional and mental approach of sportsmen, in particular football players, by transmitting signals from mobile telephones of supporters on air consists in converting the received signals into a summed audio signal, controlling the loudness of the summed audio signal and broadcasting said signal on a stadium via loudspeakers. An explanatory text for transmitting the signals from mobile telephones on air can be preliminary provided to the supporters. The text can be provided by displaying it on TV-sets during the transmission of a sports event or by means of an audio announcement. Current value of the summed signal intensity can be displayed on the screens of TV sets and/or on the video display of the stadium during the sports event TV transmission. The inventive method makes it possible for supporters outside the stadium to directly influence the emotional and mental approach of sportsmen by contributing to the background sound at the stadium and, in particular, by being able to absent participate in fan-chants performed in order to support the sportsmen, which are immediately heard by the sportsmen during the sports event.

### TECHNICAL FIELD

The invention relates to methods for influencing the emotional and mental approach of a sportsman, in particular a football player, and can be used for activating supporters, mainly not present at the stadium, by allowing them to participate in the so-called fan-chants (slogans jointly chanted by a group of people in unison) or by contributing to the overall background sound at the stadium, thus providing a significant incentive for the sportsmen during the sports event and considerably influencing the realization of their sports mastery.

### BACKGROUND ART

A known method for forming emotional and mental approach of sportsmen, including with the participation of supporters, the coach and other interested individuals, transmits the signals on air by using the mobile phones of the supporters, see RU 2001124795 A.

This method has been taken as a prototype of the present invention.

The disadvantage of the prototype method consists in that the emotional and mental approach of a sportsman is influenced by communicating to him the task of the coach by means of the abovementioned method, wherein there is no possibility to ensure his personal participation or to transmit on air the voices of the football players, their relatives, outside supporters etc. that could be heard by interested individuals and subsequently used for assessing the emotional and mental approach of a sportsman and for influencing said approach. However, the signals from the mobile phones are not transmitted on air at the stadium during the sports event, and the sportsmen cannot hear them during the match; in other words, the emotional and mental approach of a sportsman is influenced before or after the game, not during the game, and the influence is not performed in a direct way but through a system of ratings formed by the supporters, the coach and other individuals; supporters not present at the stadium and watching the match on TV cannot feel united with the supporters present at the stadium and cannot contribute to the support for their favorite sportsmen.

### SUMMARY OF THE INVENTION

It is an object of the present invention to make it possible for supporters outside the stadium to directly influence the emotional and mental approach of sportsmen by contributing to the background sound at the stadium and, in particular, by being able to absent participate in fan-chants performed in order to support the sportsmen, which are immediately heard by the sportsmen during the sports event.

According to the inventive method for forming the emotional and mental approach of sportsmen, in particular football players, by transmitting signals from mobile telephones of supporters on air, the received signals are converted into a summed audio signal, the loudness of the summed audio signal is controlled and then the summed audio signal is broadcasted on a stadium via loudspeakers; an explanatory text for transmitting the signals from mobile telephones on air can be preliminary provided to the supporters; said text also can be provided by displaying it on TV-sets during the transmission of a sports event; said text can also be provided by means of an audio announcement; current value of the summed signal intensity can be displayed on the screens of TV sets and/or on the video display of the stadium during the sports event TV transmission.

The applicant has not found any sources of information containing data on engineering solutions identical to the present invention, which enables to conclude that the invention conforms to the criterion “Novelty” (N).

Realization of the features of the present invention produces an important and interesting technical result that consists in allowing supporters outside the stadium, including supporters from other cities or countries, to participate in the vocal (noise) support of their favorite team; such supporters know that their voices join the overall chorus of supporters and are heard at the stadium, probably to a not lesser extent than the voices of supporters present at the stadium; another important result is that the sportsmen can directly feel the support of their supporters, even when the match takes place in another city or country, and thus the position of such sportsmen becomes not less advantageous that the position of the local team that is supported by local supporters.

The applicant has not found any sources of information containing data on the influence of the features of the invention on the technical result produced by the invention, which enables to conclude that the invention conforms to the criterion “Inventive Step” (IS).

### BRIEF DESCRIPTION OF THE DRAWINGS

The invention is further explained, by way of detailed description of examples of its embodiments, without reference to any drawings.

### PREFERRED EMBODIMENT

Embodiment of the method is explained on the basis of an example—a football match transmitted on television (TV). During the football match the TV-sets display text informing TV-supporters of the possibility of participating in fan-chants by means of mobile phones and showing the number that must be dialed from a mobile phone for this purpose. The abovementioned information can be included in the audio that accompanies the TV transmission. The text of the fan-chant is displayed on screen of the TV-set together with the information about the time when the supporters should start chanting, e.g. by showing countdown digits: 5, 4, 3, 2, 1—go! The text of the fan-chant and its start time can also be provided in audio form by including this information in the audio that accompanies the match.

In the first particular example, signals from mobile phones that contain an audio component are received by the mobile network operator whereupon the audio component of the signals is separated; the audio signals are mixed into a summed audio signal that is transmitted to the stadium and broadcasted via loudspeakers at the stadium, wherein the loudness of the summed audio signal is controlled, e.g. in proportion to the number of supporters that absent participate in the chanting of fan-chants and the number of supporters currently present on the stadium. Usually supporters of different teams occupy different sectors of the spectator area of the stadium, and the number of supporters present in a particular sector of the stadium can be calculated with sufficient precision on the basis of the number of sold tickets; during regulation of the loudness and the audio signal of the absent supporters it seems reasonable to assume that, for example, 50 thousand absent supporters create background sound at the stadium that is 5 times more intense than the sound created by 10 thousand supporters present at the stadium. Naturally, in any case the loudness of the broadcasted summed audio signal must not extend the maximum loudness permitted by applicable sanitary and hygienic norms and must be comparable with the natural loudness of sound generated by the supporters when the stadium is 100% full.

In another example the signals from mobile phones can contain no audio component and can be embodied as an SMS-message, a simple call to a certain number, a WAP- or US SD-request. These signals are transformed into an audio signal by initiating the playback of a fan-chant recorded to a media or used in real time (online). Regulation of loudness of the audio signal and the broadcasting of the signal through loudspeakers is done in the same way as in the first example of the method embodiment described above.

Current intensity of the summed signal from absent supporters of a particular team is shown during the TV transmission on screens of the TV-sets in graphical or numerical form by means of a known method and/or on the video display of the stadium. Such information could serve as an additional incentive both for supporters present at the stadium and for absent supporters. If current intensity of the summed signal is not shown on screens of the TV-sets during the TV transmission and is only shown on the video display of the stadium, the supporters not present at the stadium can still receive this information if the TV-transmission operators periodically show close-ups of the stadium video display.

### INDUSTRIAL APPLICABILITY

The inventive method can be implemented by means of existing technological tools—mobile telephones, mobile networks, systems for regulation, synchronization and mixing of sound (e.g. systems used in Karaoke systems), hardware-software complexes, means for stadium transmission etc., virtually without any expansion of the existing infrastructures. In applicant's opinion, this enables to conclude that the invention conforms to the criterion “Industrial Applicability” (IA).

1. A method for forming the emotional and mental approach of sportsmen, in particular football players, by transmitting signals from mobile telephones of supporters on air, characterized in that the received signals are converted into a summed audio signal, the loudness of the summed audio signal is regulated and the signal is broadcasted on a stadium via loudspeakers.

2. A method as claimed in claim 1, characterized in that an explanatory text for transmitting the signals from mobile telephones on air is preliminary provided to the supporters.

3. A method as claimed in claim 2, characterized in that the text is provided by displaying it on TV-sets during the transmission of a sports event.

4. A method as claimed in claim 2, characterized in that the text is provided by means of an audio announcement.

5. A method as claimed in claim 1, characterized in that the current value of the summed signal intensity is displayed on TV-sets and/or on the video display of the stadium during the sports event TV transmission.
